(19) United States
(12) Patent Application Publication
(10) Pub. No.: US 2010/0310425 A1
(43) Pub. Date: Dec. 9, 2010

(54) Real-time indicator detector

(75) Inventor: Samuel David Piper, Carmichael, CA (US)

Correspondence Address: Dave Piper, Suite C, 4807 El Camino Avenue, Carmichael, CA, 95608, US

(73) Assignee: Piper Medical, Inc., Carmichael, CA (US)

(21) Appl. No.: 12/802,362

(22) Filed: Jun. 4, 2010

Related U.S. Application Data
(60) Provisional application No. 61/217,961, filed on Jun. 5, 2009.

(51) Int. Cl. G01J 1/50

(52) U.S. Cl. 422/86

(57) ABSTRACT

The present invention pertains generally to a detection means for indicia provided by a primary device, and more particularly, to a detection sensor assembly adapted to measure at least one indicator moiety influenced by changing gaseous environments. A detection sensor assembly performs to collect and respond to changing gaseous environments in real-time, conveying that information to a user of the detection sensor assembly sufficiently quickly and accurately such that the user can respond to the changing gaseous environments in a timely manner. The detection sensor assembly operates using an incident receiver in the form of an indicator sensor. An indicator moiety responsive to particular elements or compounds of interest in a gaseous environment is positioned proximal to the indicator sensor such that changes in the indicator moiety are captured by operation of the indicator sensor.

### CROSS-REFERENCE TO RELATED APPLICATIONS

This application claims the benefit under 35 U.S.C. 119(e) of U.S. provisional application Ser. No. 61/217,961 filed Jun. 5, 2009, which is incorporated by reference herein in its entirety

### STATEMENT REGARDING FEDERALLY SPONSORED RESEARCH

Not Applicable

### BACKGROUND OF THE INVENTION

The ready detection of constituents of a gaseous environment is desirable wherein such detection indicates potential changes of the environment over time. Changes in a gaseous environment may indicate a variation in system or process either upstream (gaseous components feeding into the point of testing), results that might occur or be obtained downstream (wherein the gaseous environment is feeding into a system or process), and the combinations thereof. Where the detected gaseous constituents are of a critical nature in presenting effectiveness of an upstream process or to the potential of a downstream process, should the detected value indicating the quantity or quality of that gaseous component or components be outside a particular desired range or threshold, a secondary condition may be triggered. Exemplary secondary conditions include means by which an operator is alerted of the deviation outside the specified range and initiation of control means by which the gaseous constituent is directly altered.

The use of detection/response process for gaseous environment assaying and monitoring is particularly valuable to those in the agricultural, chemical manufacture, mining, fire-fighting, and medical fields. In agricultural applications, routine sampling of ethylene oxide is critical in maintaining and achieving optimal produce quality when shipped over long distances, and as such, a device which can readily sample storage environment of fresh produce and advise as to ethylene oxide in the gaseous environment is extremely beneficial. Chemical manufacturing often involves the introduction of one or more gaseous elements or compounds into a reaction chamber so as to produced a desired compound and/or the products or byproducts of such a compound formation process can be tracked to determine yield and quality. Safety concerns with regard to gaseous environments, particular wherein constituents of the gaseous environment are toxic or flammable, are a routine factor in the safe operation of mines and for fire-fighters entering a environment where the atmosphere may be unstable. A detection/response process for gaseous sampling is particularly advantageous when dealing with respiring organisms, and as such, use of a detector to determine inspiratory and/or expiratory conditions of a patient is particularly advantageous in the medical arts.

There are numerous means by which constituents, and temperature of a gaseous environment can be determined, as evidenced by the plethora of technologies and devices presented in the prior art, including electrical sensors and liquid reagent reactions vessels. While electrical sensors which act directly upon a sample of a simple gaseous environment (i.e. limited differing constituents) have the capability to be sensitive and quite accurate, contamination of the sensors themselves often preclude the re-use of that sensor for assaying a second environment. Further, it is known in the art that electrical sensors begin to lose sensitivity when the gaseous test environment become increasingly complex as the colorimetric reactants begin to overlap with other gaseous constituents in the sample. Related to one-time use electrical sensors are bubble-jar mechanisms wherein a gaseous sample is presented into a reservoir of liquid colorimetric reagent. As the gas sample is buoyantly conveyed through the liquid reservoir, the reagent chemistry within the liquid interacts with the constituents of the gaseous sample, and a perceptible change is rendered. A particular disadvantage to the use of bubble-jars, beyond the limitation of single-time usage, is the fact that real-time results are difficult to achieve due to titration effects, sample dilution and stability such reagent chemistries have over time. Significant strides in gaseous environmental assaying have been made with the introduction of indicator media and incorporation of such media into single-use, disposable carriers or housings.

Indicator devices such as those taught in U.S. Pat. No. 6,187,596 to Dallas et al., U.S. Pat. No. 6,378,522 to Pagan, and U.S. Pat. No. 6,502,573 to Ratner, each of which is included by reference in their respective entireties herein, are examples of single-use, disposable indicator assemblies wherein a colorimetric change is made visible to an operator when a particular gaseous constituent is present in a sample. These indicator devices can employ indicator media formed by various means, including indicator chemistries formed on or in porous substrates, such as taught in U.S. Pat. No. 5,005,572 to Raemer et al., and as reactive films, such as taught in U.S. Pat. No. 3,754,867 to Guenther, both of which are included by reference in their respective entireties.

Use of indicator devices relying on user perception of performance, while providing ready binary responses as the indicator media responds to gaseous constituents, suffer from a number of intrinsic and extrinsic failings. The colorimetric changes presented by the indicator media must be perceived by the operator to determine assay results. This requirement for perception of the actual indicator places a demand on the operator to be diligent in their efforts to routinely view the indicator, despite any environmental distractions that might occur, such as a medical practioner triaging a patient in an emergency room or a fire-fighter entering a burning building. The ability of an operator to view the indicator effectively can be further comprised by: obscuring of the indicator by surface contaminates on the device itself as well as any intervening between the operator's eye and the indicator; ambient static or dynamic lighting conditions; and, the ability of the operator to perceive color changes accurately (e.g. color blindness). Indicator media colorimetric changes are highly subjective and further complicate interpretation by transient conditions in the gaseous environment and responsiveness to real-time changes of the environment within a useful time period. Indicator media have been found by the inventor to be significantly effected by the temperature of the contact gas. As a result of the limitations associated with indicator media, they are primarily useful only for indicating binary changes of the constituents of respired gas, provide little quantitative data, are unable to provide information on small changes in amplitude or duration of gas concentration, and are susceptible to errant indications as a result of temperature fluctuations.

A particular application of interest wherein transient gaseous environments are assayed for presence and quantity of constituents is the field of carbon dioxide indicators for medical respiratory devices. Carbon dioxide indicators are utilized to determine the presence of carbon dioxide in expiratory gas from a patient, wherein deviation outside of norms is indicative of a problem in respiratory performance. More specifically, small deviations, abnormalities, or changes in trends of CO2 at various parts of the respiratory cycle can be used to diagnose for specific conditions. In a related application, carbon dioxide indicators can be employed in conjunction with an endotracheal tube during an intubation procedure. In the event that the endotracheal tube is incorrectly placed in a non-respiratory associated physiology (i.e. the esophagus), there will be minimal to no carbon dioxide cycled from the patient as presented by failure of the carbon dioxide indicator to present a significant color change, and thus the practioner is informed that the patient will have to be re-intubated. Again, timely response of a carbon dioxide indicator is constrained by the same operational limitations elucidated above, with the additional issues of an emergent situation demanding additional attention to the device by harried emergency medical providers and emergency medical providers that are simultaneously performing life-saving procedures. It should be noted that simply increasing the size of a carbon dioxide indicator to have a larger viewable surface and thus ease perception of colorimetric changes is contraindicated by the requirement that such increase in size would significantly magnify the volume constrained within the device itself A larger volume results in a higher percentage of expiratory gases that are captured and re-breathed by the patient, with a deleterious effect of diminishing the ability to oxygenate the patient effectively and skewing of the carbon dioxide indicator itself from the recycled trapped dead volume. Furthermore, simple colormetric co2 detectors are not able to display small variations, deviations, or abnormalities of the exhaled co2 that may be indicative of specific clinical conditions. Such clinical conditions, which simple colormetric co2 detectors are unable to detect, or provide meaningful information on, include but are not limited to: hypoventilation, hyperventilation, changes in metabolic rate, changes in body temperature, inadequate inhalation or exhalation flows, faulty ventilatory support devices, presence of foreign body in the upper airway, bronchospasm, and subsiding muscle relaxants. Such knowledge necessary to diagnose clinical conditions based on quantified CO2 concentrations and the resulting waveforms during the respiratory cycle are well known by clinicians in the field, and described in “Egan's Fundamentals of Respiratory Care”, Wilkins, et al., Elsevier Health Sciences, Ed. 9, ISBN-13: 9780323036573; “Mosby's Respiratory Care Equipment,” Cairo and Pilbeam, Elsevier Health Sciences, Ed. 8, ISBN-13: 9780323051767; “Respiratory Physiology,” West, Lippincott Williams and Wilkins, Ed. 6, ISBN-13: 9780781772068; and “Pulmonary Pathophysiology,” West, Lippincott Williams and Wilkins, Ed. 6, ISBN-13: 9780781764148, all incorporated by reference herein their entirety.

Additionally, clinicians have a responsibility to insure that devices they use to treat patients do not infect patients with bacteria, virus, molds, fungi, or other potentially viable organisms. Such an infection can often be harmful and potentially fatal. A common source of such infection is contact with devices or surfaces previously in contact with another patient who acts as a host, or source of such infection. Such infections from patient to patient is commonly called “cross patient infection” or “cross contamination.” Furthermore, clinicians need to insure that the devices that they treat patients are otherwise clean of contaminants, regardless of the viability of the contaminant as an actual infection. Such contaminants (e.g. radioactive material) is also well known to be harmful and potentially fatal. Common practices of preventing the infection or contamination of a patient through contact with a device is accomplished through various cleaning methods of the device employed between the treatment of one patient and the next, or the use of pre-packaged single patient or single use disposables. Although various cleaning and sterilization techniques are believed to work, they all require time and resources that may not be present at the time or place of treatment. The availability of resources needed for cleaning and sterilization techniques, potentially burdensome under normal circumstances, can become increasingly difficult to support under adverse circumstances in or out of a clinical institution, and can become completely unavailable in the event of a natural or man made catastrophe.

In a mass casualty event, the number of casualties presenting to a clinical situation may simply overwhelm the available resources making it necessary to share equipment among as many patients as possible. In the case of a clinical procedure that involves very little time (e.g. an injection) the time necessary to clean a medical device may be several order of magnitudes greater than the time the device is used clinically, thus the use of a device may be impractical and many patients may simply not receive needed care.

Existing light absorbing technique devices must overcome the obstacle of water vapor having an overlapping absorbance profile as compared to carbon dioxide gas, the result of which is increased sophistication and an expensive device. Often the cost of these light absorbing device are more than a couple thousand US dollars. Furthermore, the sophistication and mass of these devices makes them more vulnerable to breaking from handling and less suitable for portability.

Therefore, there remains an unmet need for a method and means for readily detecting changes in an associated disposable indicator assemblies and rendering an objective result there from in real-time that is quantitative, capable of detecting and displaying minor changes in magnitude and duration, is specific to a desired constituent, is unaffected by untargeted constituents, is portable, and is inexpensive.

### SUMMARY OF THE INVENTION

The present invention pertains generally to a detection means for indicia provided by a primary device, and more particularly, to a detection sensor assembly adapted to measure at least one indicator moiety influenced by changing gaseous environments in real-time and conveying that information to a user of the detection sensor assembly sufficiently quickly, quantitatively, and accurately such that the user can respond to large and small changes of magnitude and duration of the changing gaseous environments in a timely manner.

In a preferred embodiment, a detection sensor assembly is adapted to measure at least one indicator moiety influenced by changing gaseous environments using at least one incident receiver and optionally at least one illumination source. An indicator moiety responsive to particular elements or compounds of interest in a gaseous environment is positioned proximal to the incident receiver such that changes in the indicator moiety are exposed to incident receiver, the changes then being captured by operation of the incident receiver.

In a further embodiment, a detection sensor assembly is adapted to measure at least one indicator moiety influenced by changing gaseous environments and operates using at least one illumination source at a provided wavelength and at least one incident receiver responsive to a specific wavelength. An indicator moiety responsive to particular elements or compounds of interest in a gaseous environment is positioned proximal to the illumination source and incident receiver such that changes in the indicator moiety are exposed by the wavelength of the illumination source, the changes then being captured by operation of the incident receiver responsive to a specific wavelength.

In a further embodiment, a detection sensor assembly is adapted to measure at least one indicator moiety influenced by changing gaseous environments operates using at least one illumination source at a provided visual wavelength and at least one incident receiver responsive to a specific visual wavelength. An indicator moiety responsive to particular elements or compounds of interest in a gaseous environment is positioned proximal to the illumination source and incident receiver such that changes in the indicator moiety are exposed by the visual wavelength of the illumination source, the changes then being captured by operation of the incident receiver responsive to a specific visual wavelength.

In a further embodiment, a detection sensor assembly is adapted to measure at least one indicator moiety influenced by changing gaseous environments operates using at least one illumination source in a range of wavelengths and at least one incident receiver responsive to a specific wavelength. An indicator moiety responsive to particular elements or compounds of interest in a gaseous environment is positioned proximal to the illumination source and incident receiver such that changes in the indicator moiety are exposed by the wavelengths of the illumination source, the changes then being captured by operation of the incident receiver responsive to a specific wavelength.

In a further embodiment, a detection sensor assembly is adapted to measure at least one indicator moiety influenced by changing gaseous environments operates using at least one illumination source in a range of wavelengths and at least one incident receiver responsive to a range of wavelengths. An indicator moiety responsive to particular elements or compounds of interest in a gaseous environment is positioned proximal to the illumination source and incident receiver such that changes in the indicator moiety are exposed by the wavelengths of the illumination source, the changes then being captured by operation of the incident receiver responsive to a range of wavelengths.

In a further embodiment, a detection sensor assembly is adapted to measure at least one indicator moiety influenced by changing gaseous environments operates using at least one illumination source in at least one wavelength and at least one incident receiver responsive to a at least one wavelength different than at least one said illumination wavelength. An indicator moiety responsive to particular elements or compounds of interest in a gaseous environment is positioned proximal to the illumination source and incident receiver such that changes in the indicator moiety are exposed by the wavelengths of the illumination source, the changes then being captured by operation of the incident receiver responsive to a range of wavelengths.

In further embodiments, the aforementioned detection sensor assemblies are universally adaptable to commercially available disposable indicator assemblies by means of a mounting fixture.

In a further embodiment, the aforementioned detection sensor assemblies are specifically adaptable to commercially available disposable indicator assemblies by means of a modular mounting fixture.

In a further embodiment, the aforementioned detection sensor assemblies are universally adaptable to commercially available disposable indicator assemblies by means of a mounting fixture.

In a further embodiment, the aforementioned detection sensor assemblies are mounted to a specifically designed disposable indicator assemblies by means of a mounting fixture.

In a further embodiment, the aforementioned detection sensor assemblies include an indicator moiety responsive to a singular gaseous compound, element or constituent.

In a further embodiment, the aforementioned detection sensor assemblies include an indicator moiety responsive to plural gaseous compounds, elements and/or constituents.

In a further embodiment, the aforementioned indicator moiety is used in conjunction with one or more reference or control indicia.

In a further embodiment, the aforementioned indicator moiety is mounted to a structure wherein the structure is responsive to gaseous flow through the associated detection sensor assembly. A preferred embodiment is an indicator moiety mounted to a structure that responds to the degree of force applied to the structure by the gaseous flow.

In a further embodiment, the aforementioned indicator moiety comprises one or more reagent chemistries, wherein the reagent chemistries are positioned in different regions of a viewable area defined by the at least one illumination source and at least one incident receiver.

In a further embodiment, the aforementioned indicator moiety comprises one or more reagent chemistries, wherein the reagent chemistries react to differing gaseous compounds, elements and/or constituents.

In a further embodiment, the aforementioned detection sensor assemblies then trigger at least one electronic devices; representative electronic devices including, but not limited to, means of notification to the user of a change in gaseous environment, modification of the gaseous environment itself, and data interpretation wherein a related process of the gaseous environment is determined in real-time.

In a further embodiment, the aforementioned detection sensor assembly is used to detect at least one flammable, toxic, carcinogenic or hazardous gaseous compound, element and/or constituent.

In a further embodiment, the aforementioned detection sensor assembly is used to detect carbon dioxide, and in a particularly preferred embodiment, to detect end tidal carbon dioxide concentration in an expiratory gas.

In a further embodiment, the detection sensor assembly includes a thermistor or other temperature probe for measuring ambient temperature and thus providing the means for temperature correction.

In a further embodiment, the detection sensor assembly has the means to detect an additional indicator target. Said additional indicator target is included in flow housing and is detectable through indicator window, but is not exposed to the gas flowing through the flow housing. Said additional indicator target may be of the same lot of chemistry used by the other indicator targets in the flow housing. Thereby, said additional indicator target provides the means for temperature and process variability correction.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The invention will be more easily understood by a detailed explanation of the invention including drawings. Accordingly, drawings which are particularly suited for explaining the inventions are attached herewith; however, it should be understood that such drawings are for descriptive purposes only and as thus are not necessarily to scale beyond the measurements provided. The drawings are briefly described as follows:

FIG. 1 is a waveform as displayed by a device in accordance with the present invention in fluidic communication with a normally respiring patient, wherein the varying line represents varying carbon dioxide concentrations corresponding to respiratory phases of the patient,

FIG. 2 is a cross-sectional profile of a device in accordance with the present invention; wherein a straight flow is directed in at least part to an indicator target and wherein the indicator target is proximal to an indicator sensor,

FIG. 3 is a modular detection assembly with a user interface, user operated input and a receptacle for a disposable indicator housing,

FIG. 4 is a back-up view of a modular detection assembly as in FIG. 8 wherein an indicator sensor, illumination source and associated receptacle for a disposable indicator housing are provided,

FIG. 5 is a front perspective-exploded view of a modular detection assembly as in FIG. 3,

FIG. 6 is a back perspective-exploded view of a modular detection assembly as in FIG. 3,

FIG. 7 is a front view of a modular detection assembly as in FIG. 3, FIG. 8 is a bottom perspective view of a modular detection assembly as in FIG. 3,

FIG. 9 is a right side cross-sectional view of a modular detection assembly as in FIG. 3,

FIG. 10 is a right side cross view of a modular detection assembly as in FIG. 3,

FIG. 11 is a bottom-up view of a modular detection assembly as in FIG. 8 wherein a receptacle for a disposable indicator housing is depicted,

FIG. 12 is a front perspective-exploded view of a representative disposable indicator housing in accordance with the present invention,

FIG. 13 is a front perspective view of a reagent chemistry assembly as included as a component of FIG. 12,

FIG. 14 is a front perspective-exploded view of a reagent chemistry assembly as in FIG. 13,

FIG. 15 is a front view of a reagent chemistry assembly as in FIG. 13,

FIG. 16 is a sectional view of a reagent chemistry assembly as in FIG. 13,

FIG. 17 is a is a back perspective-exploded view of a disposable indicator housing as in FIG. 12,

FIG. 18 is a top perspective view of a disposable indicator housing as in FIG. 12,

FIG. 19 is a bottom perspective view of a disposable indicator housing as in FIG. 12,

FIG. 20 is a right side cross-sectional view o of a disposable indicator housing as in FIG. 12 and related airway connectors,

FIG. 21 is a right side view of a of a disposable indicator housing as in FIG. 12 and related airway connectors,

FIG. 22 is a top view of a disposable indicator housing as in FIG. 12 and related airway connectors,

FIG. 23 is a top perspective-exploded view of a of a modular detection assembly as in FIG. 3 and of a disposable indicator housing as in FIG. 12 and related airway connectors,

FIG. 24 is a bottom perspective-exploded view of a of a modular detection assembly as in FIG. 3 and of a disposable indicator housing as in FIG. 12 and related airway connectors,

FIG. 25 is a is a top perspective view of a of a modular detection assembly as in FIG. 3 adjoined to a disposable indicator housing as in FIG. 12 and related airway connectors,

FIG. 26 is a is a bottom perspective view of a of a modular detection assembly as in FIG. 3 adjoined to a disposable indicator housing as in FIG. 12 and related airway connectors,

FIG. 27 is a right side cross-sectional view of a modular detection assembly as in FIG. 3 adjoined to a disposable indicator housing as in FIG. 12 and related airway connectors,

LIST OF REFERENCE NUMERALS

| | |
|---|---|
| 2 | developed inspiratory CO2 |
| 4 | end inspiratory CO2 |
| 6 | developed expiratory CO2 |
| 8 | end tidal CO2 |
| 10 | detection assembly |
| 12 | indicator sensor |
| 14 | illumination source |
| 20 | indicator window |
| 22 | indicator target |
| 24 | indicator fitting |
| 30 | indicator housing |
| 32 | flow diverter |
| 34 | ambient port |
| 36 | patient connection port |
| 40 | communication cable |
| 50 | control unit |
| 51 | electronic sensor housing |
| 52 | chassis |
| 54 | electronic cover |
| 56 | LCD screen |
| 58 | membrane switches |
| 60 | battery cover |
| 62 | flow housing receptacle |
| 63 | light shroud |
| 64 | batteries |
| 65 | detent |
| 66 | signal illumination source |
| 68 | signal sensor |
| 70 | signal sensor housing |
| 72 | reference illumination source |
| 74 | reference sensor |
| 76 | reference sensor housing |
| 78 | circuit board |
| 80 | membrane switch ribbon cable |
| 82 | ribbon cable port |
| 84 | ribbon cable connector |
| 86 | signal illumination source boss carriage |
| 88 | signal sensor housing port |
| 90 | reference illumination source boss carriag |
| 92 | reference sensor housing port |
| 94 | stand offs |
| 96 | LCD window |
| 98 | battery receptacle |
| 100 | flow housing assembly |
| 102 | cap |
| 104 | flow top |
| 106 | flow base |
| 108 | lip |
| 110 | light shield |
| 112 | engagement pockets |
| 114 | engagement teeth |
| 116 | distal port |
| 118 | patient port |
| 120 | male conical connector |
| 122 | female conical connector |
| 124 | flow mesh array |
| 126 | patient port outer cylindrical body |
| 128 | distal conduit |
| 130 | indicator chamber |
| 200 | indicator assembly |
| 202 | sensing indicator |
| 204 | reference indicator |
| 206 | indicator base |
| 208 | reference barrier |
| 210 | sensing flow conduit |

### DETAILED DESCRIPTION OF THE INVENTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

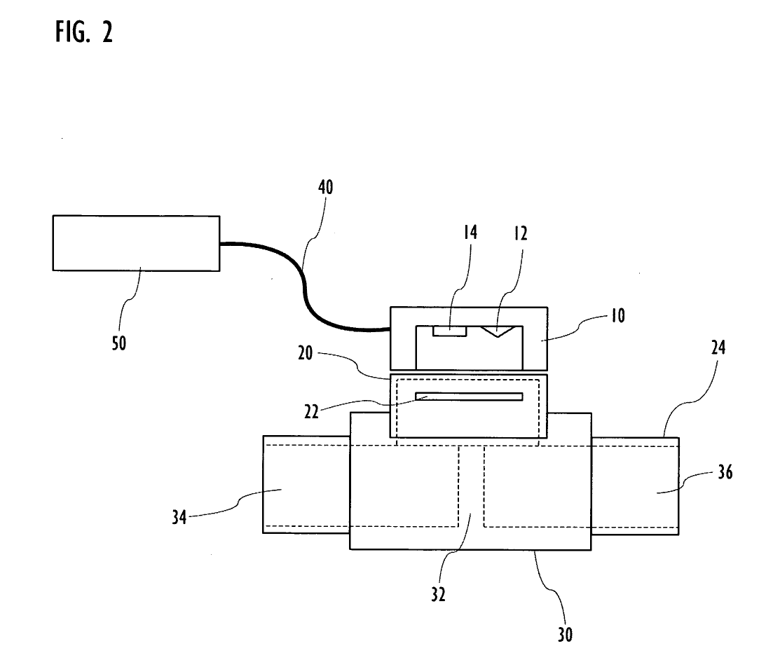

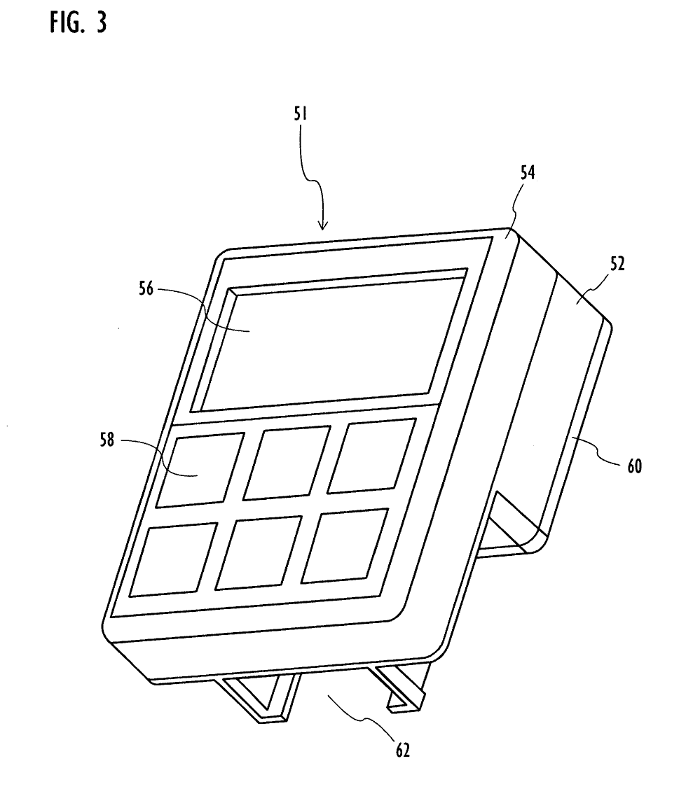

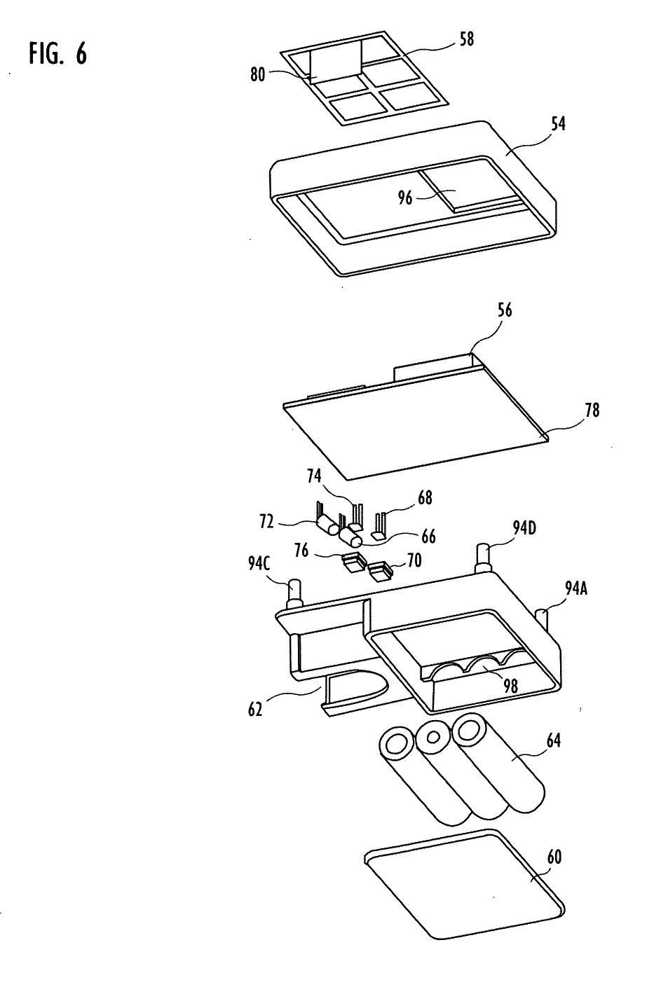

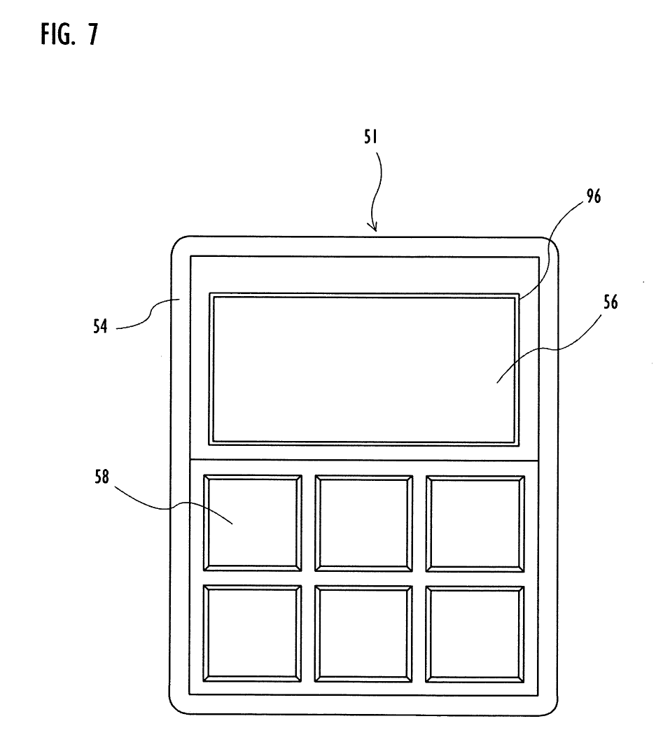

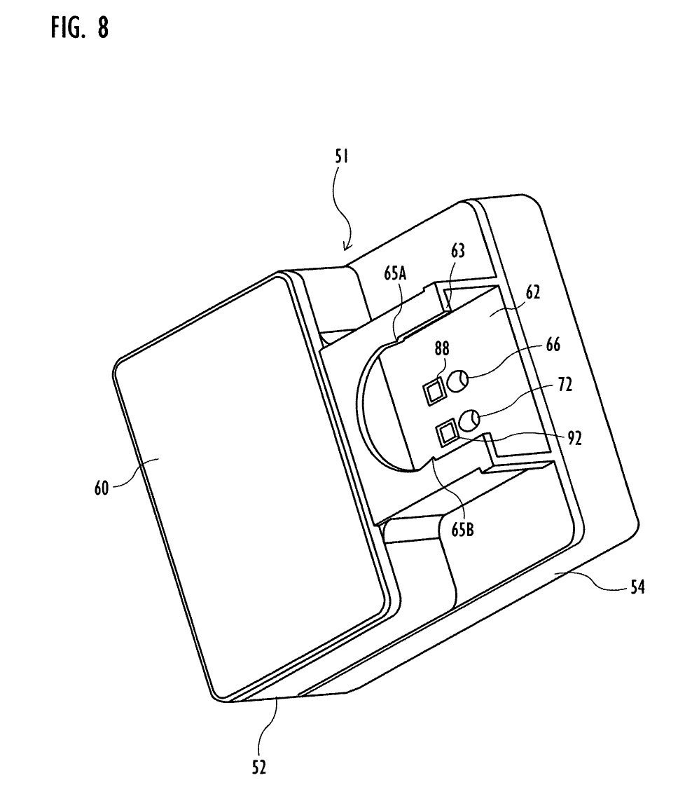

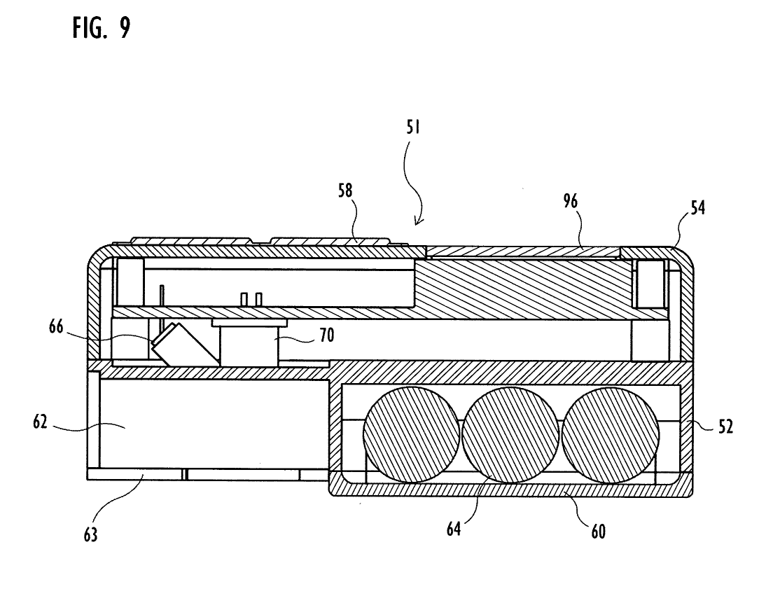

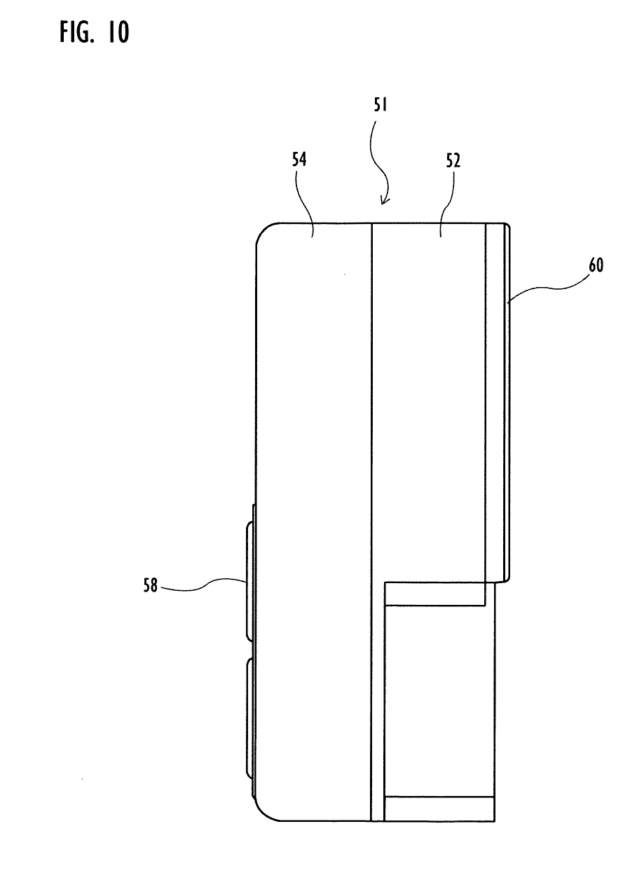

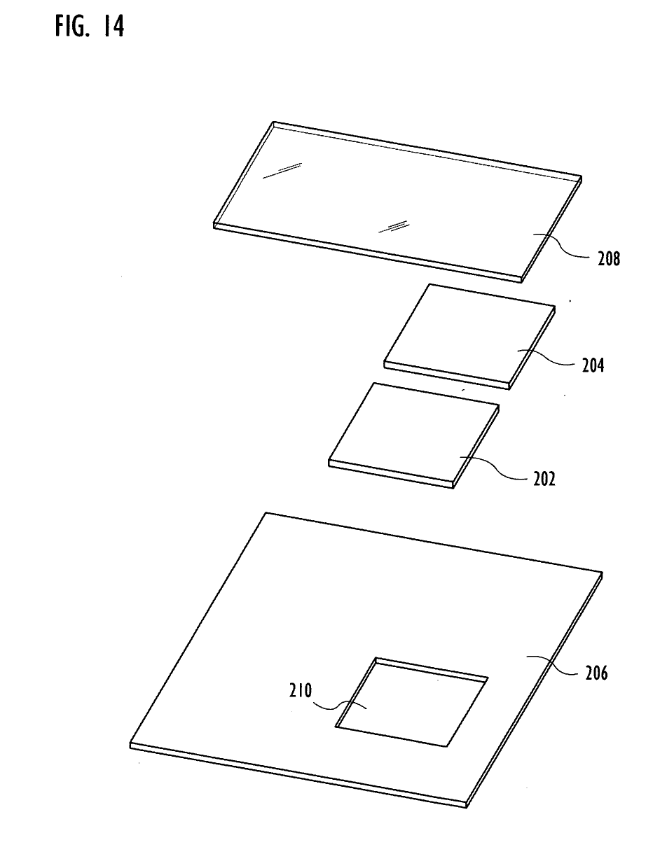

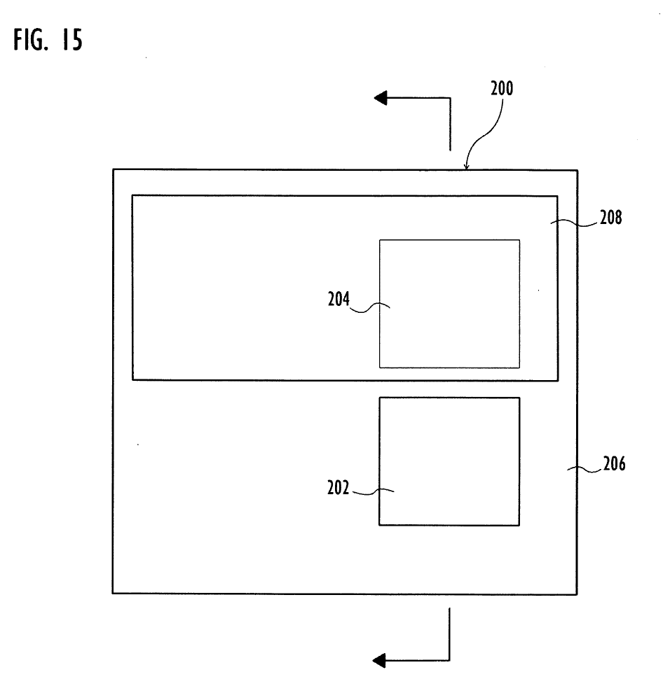

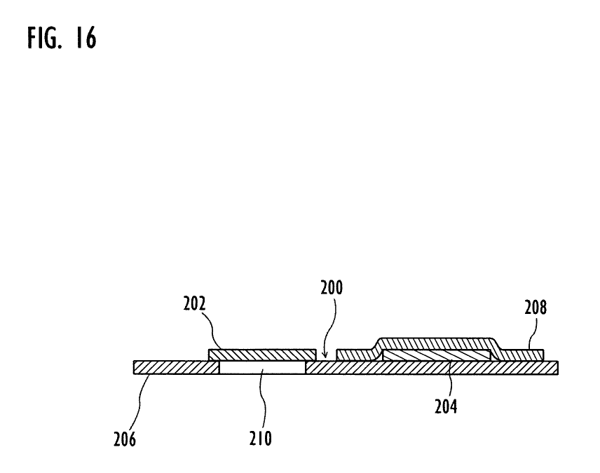

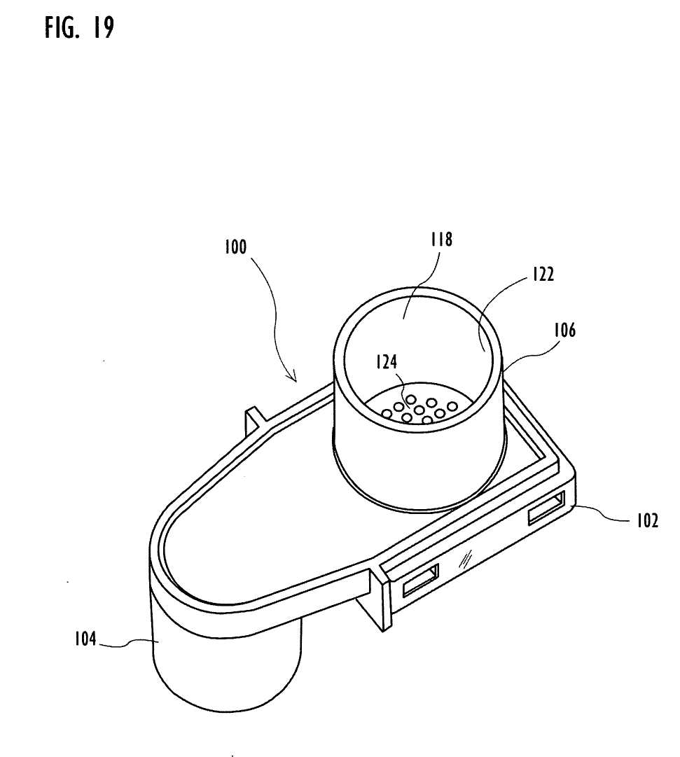

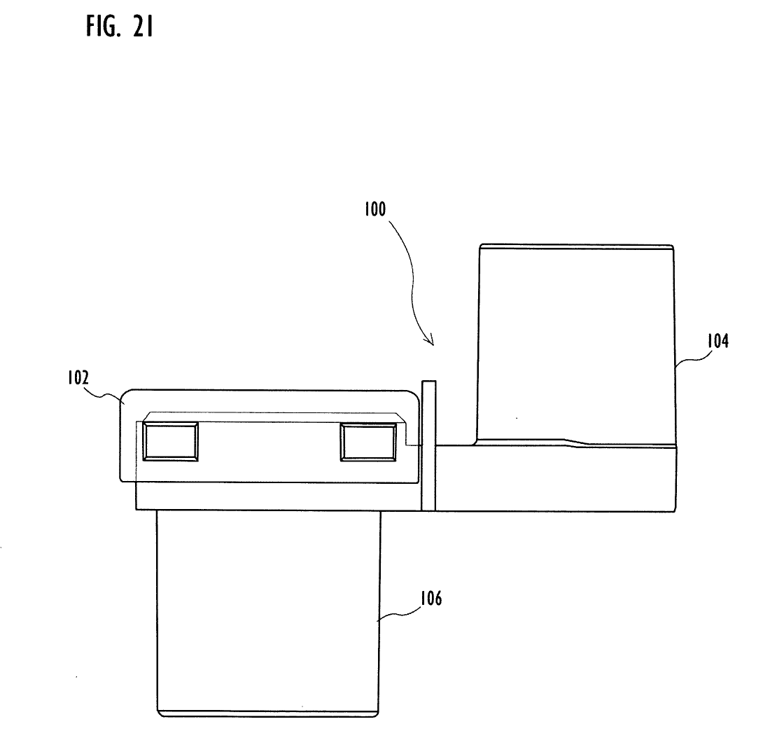

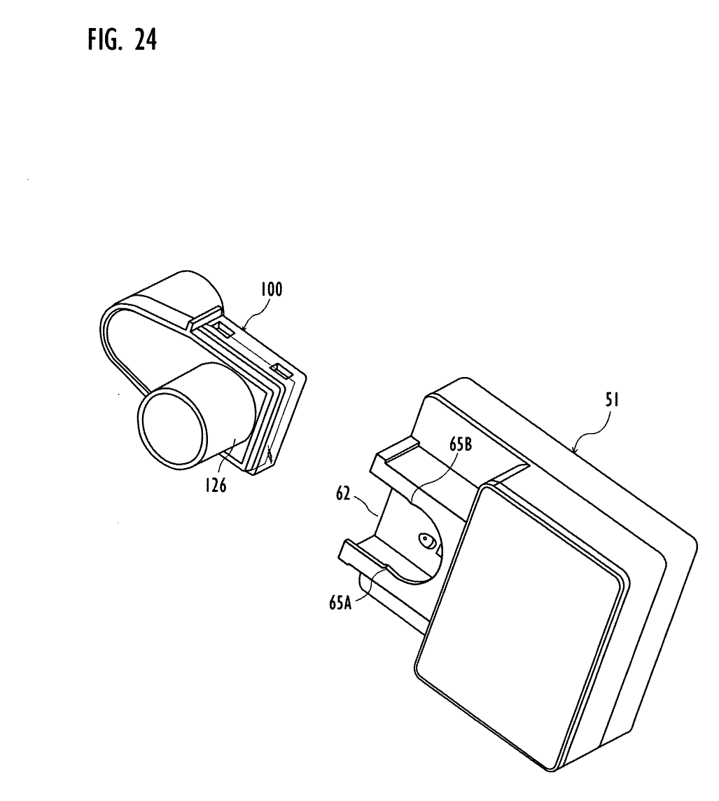

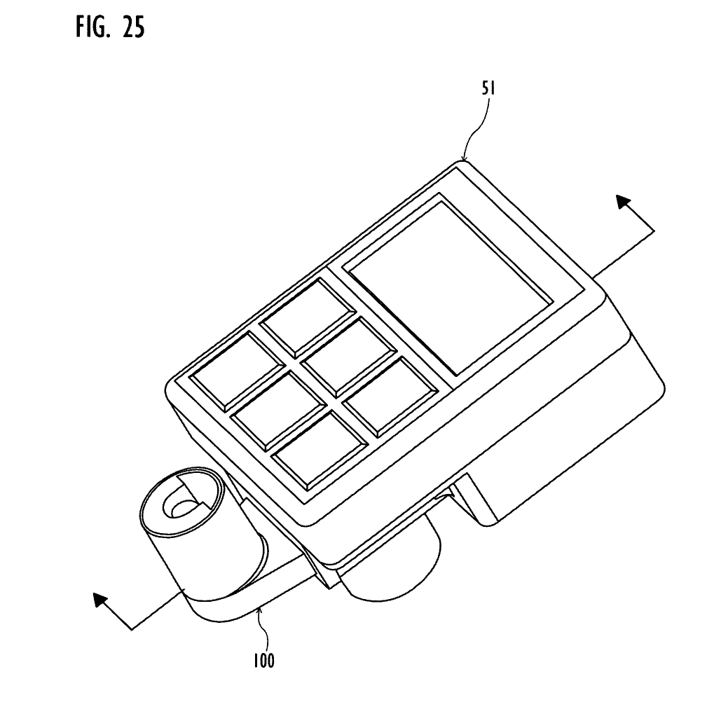

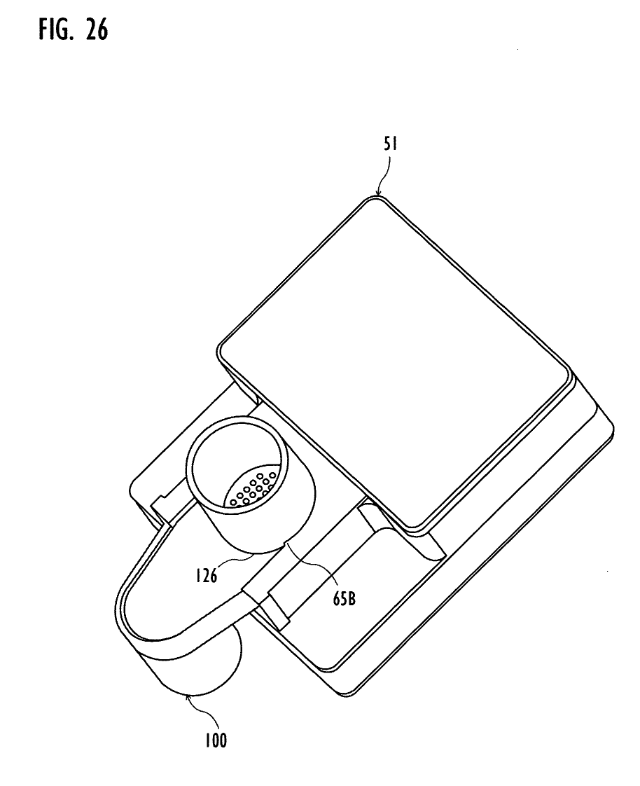

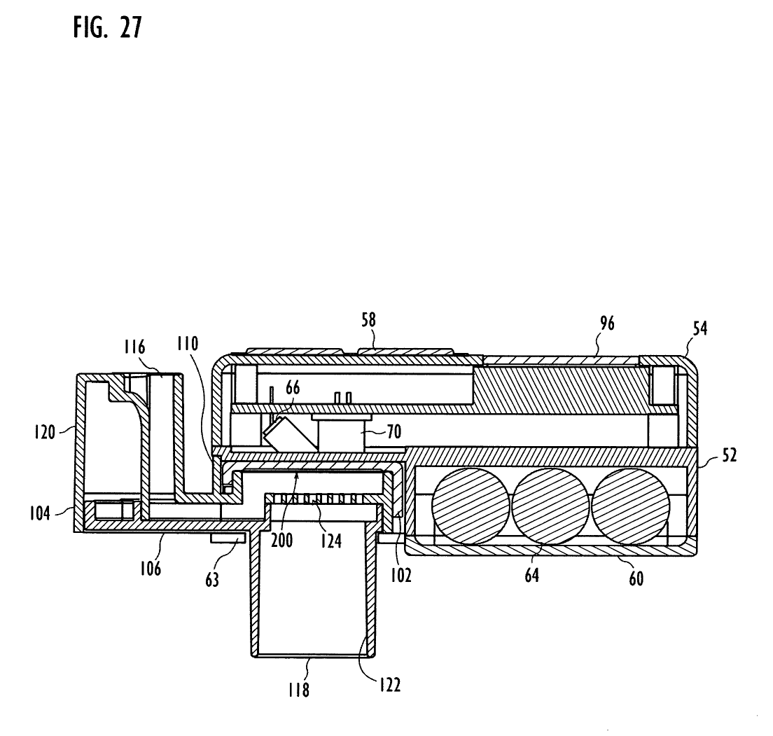

For illustrative purposes the present invention is embodied in the apparati generally shown in FIG. 2 through 27. Referring first to FIG. 2, the present invention pertains to a detection sensor assembly 10 adapted to measure at least one indication moiety influenced by changing gaseous environments within a representative indicator housing 30. Indicator housing 30 comprises a fluidic intake 34, and fluidic outlet 36, and positioned with a flow path defined by fluidic intake 34 and fluidic outlet 36 is a flow diverter 32. Flow diverter 32 redirects at least a portion of the fluidic flow of gas moving through said indicator housing such that the gas flow comes into contact with indicator target 22. Various embodiments of the invention may include the flow diverter as a specific element within the body or may, by the overall design of the body, incorporate the same desired effect, direction of a portion of the fluidic flow of gas such that at least a portion of the fluid flow of gas moving through said indicator housing comes into contact with indicator target 22, without departing from the specifics of the invention. The main advantage of directing a portion of the fluidic flow of gas such that at least a portion of the fluid flow of gas moving through said indicator housing comes into contact with indicator target 22 is that it increases the rate of response of the resulting signal, thereby assisting in obtaining a total system response time of less than 500 msec, which is desirable. A particular embodiment of an indicator assembly is depicted in FIG.2, though it should be understood that other indicator housings may be employed such as taught in U.S. Pat. No. 5,197,464 to Babb et al., U.S. Pat. No. 6,190,327 to Isaacson et al., U.S. Pat. No. 6,502,573 to Ratner et al., and U.S. Pat. No. 7,246,622 to Geist, each of the aforementioned citations being incorporated by reference in their respective entireties.

In basic operation, a fluid such as a gas sample is conveyed through fluidic intake 34 whereupon the gas sample is at least in part redirected to indicator target 22. Upon exposure of indicator target 22 to the gas sample, if the gas sample contains a target species for which the indicator target 22 includes an indication moiety reactant to said target species, the indicator target 22 will present a response. Representative chemistries by which indicator target 22 may be manufactured or constructed include U.S. Pat. No. 4,752,447 to Kimmel et al., U.S. Pat. No. 4,879,999 to Leiman et al., U.S. Pat. No. 4,790,327 to Despotis, U.S. Pat. No. 4,928,687 to Lampotang et al., and Published U.S. Pat. No. 7,578,971 to Ratner et al., each of the aforementioned citations being incorporated by reference in their respective entireties. The response of indicator target 22 is presented to the exterior of indicator housing 22 by way of an indicator window 20.

An indicator moiety responsive to particular elements or compounds of interest in a fluidic environment is positioned proximal to the illumination source and incident receiver such that changes in the indicator moiety are exposed to the illumination source, the changes then being captured by operation of the incident receiver. In a preferred embodiment, a detection sensor assembly 10 comprising an indicator sensor 12 and an optional illumination source 14 are positioned proximal to indicator window 20 so as to detect a response produced by indicator target 22. Indicator sensor 12 may be an electronically controlled device which can respond to changes in frequency, transmission or intensity of radiant energy (i.e. light) within the visual, infrared, and ultraviolet wavelengths, and the combinations of wavelengths and modes of response thereof. In a preferred embodiment, indicator sensor 12 is responsive to at least one change in wavelength presented by indicator target 22 and more particularly, is responsive to at least two changes in wavelengths as presented by indicator target 22. Representative changes in wavelength as presented by indicator target 22, when the indicator target 22 includes a Thymol Blue chemistry, includes a shift in color from blue to yellow when presented with increasing carbon dioxide concentration in a gas sample, and yellow back to blue with decreasing carbon dioxide concentration. Dependent upon the nature of detection embodied within indicator sensor 12, an illumination source 14 may be used in conjunction with the sensor to determine from indicator target 22 a change in frequency, transmission or intensity within the visual, infrared, and ultraviolet wavelengths, and the combinations of wavelengths and modes of response thereof In a preferred embodiment, illumination source 14 provides a source of at least one wavelength to indicator target 22 for detection of a response therefrom.

The detection sensor assembly may then trigger one or more electronic devices; representative electronic devices including, but not limited to, means of notification to the user of a change in gaseous environment, modification of the gaseous environment itself, and data interpretation wherein a related process of the gaseous environment is determined. FIG. 3 through 27 depict a representative electronic device as associated with a detection sensor assembly. A particular embodiment of the present invention utilizes an LCD screen as a means of presenting information and waveforms obtained from the indicator sensor 12. Information which may processed by logical and control circuitry within the electronic device based on input from the indicator sensor 12 is degree of indicator target 22 change, rate of indicator target 22 change, presence of one or more changes on indicator target 22 and the combinations thereof Further, information provided by indicator sensor 12 may be compiled against operational parameters entered into the logical and control circuitry such that performance or error conditions can be presented to the user. The user of the detection sensor assembly may also input information into the logic and control circuitry by way of button, knobs, switches, or other like data-entry devices.

In addition to an indicator target 22 providing a change to indicator sensor 12, pre-defined indicia maybe be included. Pre-defined indicia, such as pre-printed markings, within the field of view of indicator sensor 12 can be used to provide control input by which the logical control circuitry can establish proper performance of indicator sensor 12 on a continuous or intermittent time schedule. Additional functionality that is responsive to fluidic flow through the indicator housing 30, such as by mechanical and/or electrical triggers (e.g. manometer or flow actuated valve) can present at least one indicator target, at least one the indicia, or combinations of at least one indicator target and at least one indicia to the indicator sensor 12. When a mechanical or electrical trigger are present, the logical and control circuitry may be programmed to be responsive to changes in flow attribute in conjunction with changes in flow composition.

The use of the terminology “Fluidic Intake” and “Fluidic Outlet” should not be construed as limiting the direction of fluid flow, since in some cases (e.g. a respiring patient), fluid may flow in one direction during one state (e.g. inhalation) and then the other direction during a different state (e.g. exhalation). Furthermore, since this embodiment of the invention works on the basis of receipt of radiant energy it is important in the fabrication of the device that means, such as the use of opaque materials, be employed to prevent ambient or stray light from outside detection assembly 10 from shining on indicator sensor 12 during operation.

### First Example

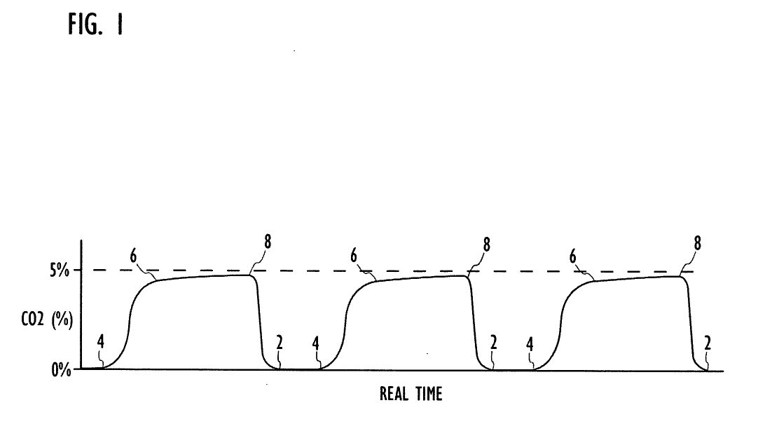

Various embodiments of the invention include presenting information to the clinician in a alpha-numerical format, in a waveform format (where one axis represents the concentration of the desired constituent and the other axis represents time or some other desired variable such as time or flow), a bar graph, audibly or combinations thereof. FIG. 1 depicts the waveform presented on the LCD screen of an embodiment of the invention that utilizes display of information in a waveform format, where the desired constituent gas is carbon dioxide (vertical axis) and the horizontal axis is a representation of time. End tidal co2 8 by itself represents valuable information for the clinician monitoring the patient and may in some embodiments also, or instead of, be displayed as a numerical value. In addition, other useful information may be determined from the shape and trend of the waveform. The region bounded by end tidal co2 8 and end inspiratory co2 4 represents the patients inhalation phase. The region bounded by end inspiratory co2 4 and end tidal co2 8 represents the patients exhalation. A number of clinical conditions can be detected through observation of the waveform. For example, a decreasing carbon dioxide concentration of the plateau between developed expiratory CO2 6 and end tidal CO2 8 is sometimes an indication of hyperventilation through an increase in respiratory rate or tidal volume, a decrease in metabolic rate, or a fall in body temperature. An increase in the baseline carbon dioxide concentration between developed inspiratory CO2 2 and end inspiratory CO2 4 is sometimes an indication of inadequate inspiratory flow, a faulty expiratory valve of a ventilatory support device, rebreathing of exhaled gas, or insufficient expiratory time. A change in the plateau between developed expiratory CO2 6 and end tidal CO2 8 such that the end tidal CO2 8 becomes significantly greater than the developed expiratory CO2 6 is sometimes an indication of obstruction in the expiratory path of a breathing circuit or ventilatory support device, presence of a foreign body in the patient's upper airway, or bronchospasm. A momentary dip in the carbon dioxide concentration plateau between developed expiratory CO2 6 and end tidal CO2 8 is sometimes an indication of the subsiding of a muscle relaxant medication given to the patient and is suggestive of the return of the patients ability to spontaneously breath, thus the magnitude of the momentary dip is inversely proportional to the degree in drug activity. An increase in the duration of time between end tidal CO2 8 and developed inspiratory 2 is sometimes an indication of a leaky or deflated endotracheal tube cuff or an endotracheal tube or other artificial airway that is too small for the patient. Other clinical conditions exist which may be indicated by changes in carbon dioxide that the current invention would be capable of providing useful information, and the above list is meant only to provide some useful examples and not to be construed as limiting of the invention.

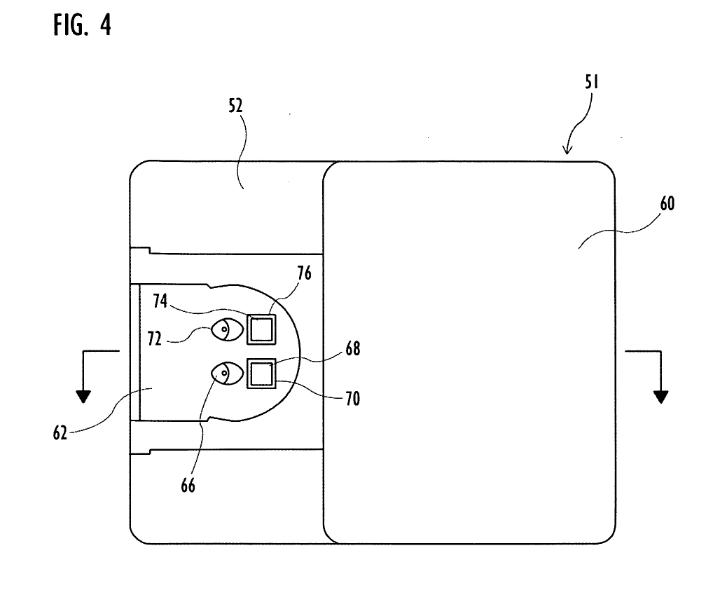

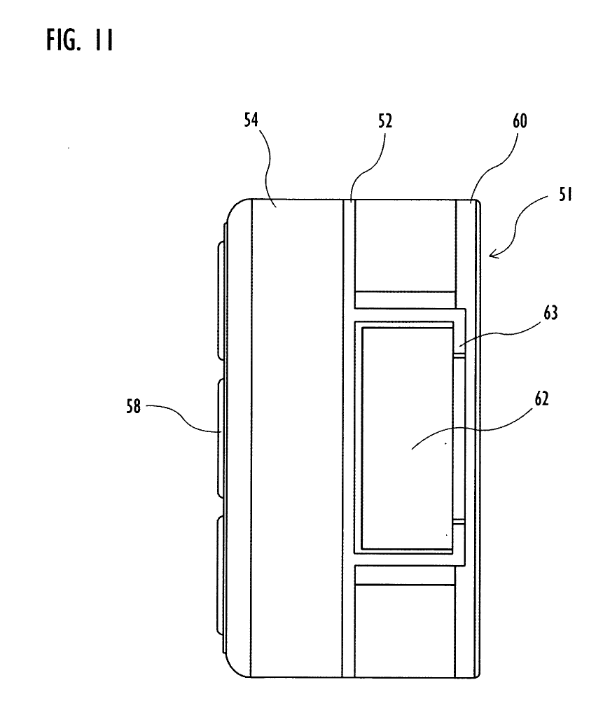

Multiple devices were constructed in accordance with the teachings of this disclosure, wherein the indicator target 22 utilized varying chemistries and differing indicator concentrations. An electronic sensor housing 51 was manufactured in accordance with FIG. 3. through FIG. 11. that combined the features and function of control unit 50 and detection assembly 10 in one unit. Although this has the advantage of simplifying the electronic assembly and is more portable, it has the disadvantage of putting more weight on the endotracheal tube and thus increasing the risk of dislodging it. Those skilled in the art shall appreciate that either configuration would be equally manufacturable. Referring to FIG. 3. the outer exposed constituents of the electronic sensor housing 51 included chassis 52, electronic cover 54, LCD screen 56, membrane switches 58, battery cover 60, and flow housing receptacle 62. Referring to FIG. 4. flow receptacle housing 62 of electronic housing 51 includes signal illumination source 66, signal sensor 68, signal sensor housing 70, reference illumination source 72, reference sensor 74, and reference sensor housing 76.

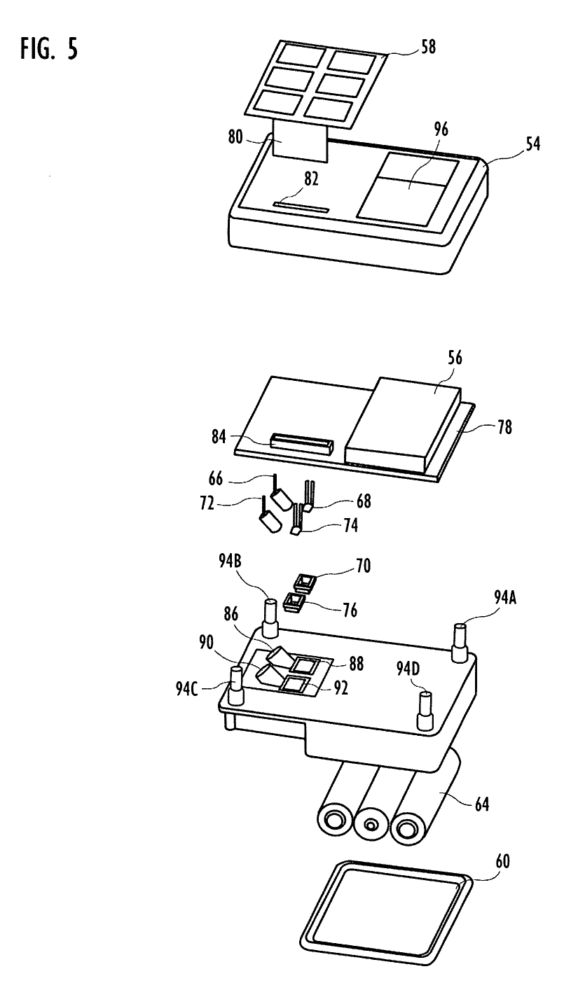

Facilitation of a better understanding of the components and how they are assembled may be realized by referring to FIG. 5. Therein can be seen circuit board 78, membrane switch ribbon cable 80, ribbon cable port 82, ribbon cable connector 84, signal illumination source boss carriage 86, signal sensor housing port 88, reference illumination source boss carriage 90, and reference sensor housing port 92. Signal illumination source boss carriage 86 and reference illumination source boss carriage 90 are equipped with an internal diameter sufficient to allow a snug slide fit of signal illumination source 66 and reference illumination source 72 respectively. Signal illumination source 66 and reference illumination source 72 both used 3 mm amber LEDs, that provided a range of wavelengths with a peak at 612 nm, and a intensity of 390 mcd (manufactured by Optoelectronics, part number AND262HAP), are electrically powered, and are equipped with a shoulder that sets the depth of assembly into signal illumination source boss carriage 86 and reference illumination source boss carriage 90. Signal sensor 68 and reference sensor 74 both used an electrically powered light to digital converter that was responsive to a broad range of wavelengths (manufactured by Texas Advanced Optoelectronic Solutions, part number TSL2561T). Signal sensor 68 and reference sensor 74 were utilized to measure intensity of radiant energy provided solely by signal illumination source 66 and reference illumination source 72 respectively, and which was reflected off sensing indicator 202 and reference indicator 204 respectively when flow housing assembly 100 was engaged with electronic sensor housing 51 as herein described in more detail. Upon signal sensor 68 and reference sensor 74 receiving varying intensities of radiant energy corresponding to changes in sensing indicator 202 and reference indicator 204 (caused by varying conditions in flow housing assembly 100), signal sensor 68 and reference sensor 74 created electrical signals corresponding to the intensity of their respective received radiant energy that were integrated into the larger workings of circuit board 78 as herein described. Although the described embodiment utilizes the intensity of a wavelength range of reflected radiant energy to produce a changing electrical signal, a number of other strategies could have been utilized as well such as: 1. using a different sensor sensitive to changing color (i.e. changing wavelength) of reflected light coming off of sensing indicator 202 and reference indicator 204; 2. using semi-transparent media for sensing indicator 202 and reference indicator 204 such that repositioned signal sensor 68 and reference sensor 74 could receive radiant energy transmitted through, instead of reflected by, sensing indicator 202 and reference indicator 204, and thus produce an equally useful electrical signal; 3. utilizing a different components for signal illumination source 66 and reference illumination source 72 such that both emitted only one wavelength of radiant energy; and 3. combinations thereof. The particular embodiment described in detail herein was chosen because it involved approximately the easiest and least expensive components to acquire and was shown to produce the desired response.

Circuit board 78 is equipped, in addition to amplifiers, conditioning elements, logic elements, and reference voltage devices as are well known by those skilled in the art, a microprocessor chip with a program memory size of 8 k×14, a ram size of 368×8, 33 I/O ports, and a 4 MHZ clock speed (manufactured by Microchip Technology, part number pic16F877-04/P). The microprocessor is programmed to handle the incoming signal and control the LCD to present processed information on CO2 waveforms, end tidal CO2 values, respiratory rate, inspiratory to expiratory time ratio, as well as alarms triggered by low end tidal CO2, high end tidal CO2, high respiratory rate, and low respiratory rate values. The microprocessor receives processed signals from signal sensor 66 and reference sensor 72, and is programmed such as to use the deviation of the two as an indication of the true CO2 concentration, thus providing for the means to control against known temperature and process variabilities and provide valuable information through activation and control of LCD screen 56 and an audible buzzer incorporated onto circuit board 78 such as to be able provide clinicians audible indication of information and alarms. With the exception of membrane switch 58, signal illumination source 66, and reference illumination source 72, circuit board 78 is assembled prior to attachment to chassis 52. Signal sensor 68 and reference sensor 74 are soldered directly onto circuit board 78 as part of the circuit board assembly procedure. Signal sensor housing 70 and reference sensor housing 76 are then both placed over signal sensor 68 and reference sensor 74 respectively and epoxied into place. Prior to attachment of circuit board 78 to chassis 52, signal illumination source 66 and reference illumination source 72 are inserted into signal illumination source boss carriage 86 and reference illumination source boss carriage 90 respectively, at which point their leads are bent to point directly perpendicular to primary face of chassis 52. Circuit board 78 is then fitted onto stand offs 94 such that the leads of signal illumination source 66 and reference illumination source 72 pass through designated holes on the circuit board where they are attached by soldering to secure the necessary electrical connection. Upon setting of circuit board 78 onto stand offs 94 (A,B,C, and D), signal sensor housing 70 and reference sensor housing 76 are caused to engage and mate with signal sensor housing port 88 and reference sensor housing port 92 respectively. Circuit board 78 is then held in place by the engagement of 6-32 screws axially aligned and centrally positioned into stand offs 94.

Membrane switches 58 are equipped with membrane switch ribbon cable 80 and a self-adhesive backing. Upon exposure of membrane switches 58 self adhesive backing, membrane switch ribbon cable 80 is caused to be passed through ribbon cable port 82 of electronic cover 54 such that the self adhesive back of membrane switches 58 is caused to adhere to the front exposed face of electronic cover 54. Membrane switch ribbon cable 80 is then caused to be joined to ribbon cable connector 84 of circuit board 78. As is commonly used by those skilled in the art, ribbon cable connector 84 is of such a design that it traps and engages the electronic connections of membrane switch ribbon cable 80 upon being joined. Once membrane switches 58 are connected to circuit board 78 it provides the means for clinician to select modes, alarms, and control settings they deem desirable. Electronic cover 54 is equipped with LCD window 96 that is a transparent material, such as polycarbonate, such that the clinician may view the display of LCD 56 while at the same time providing some manner of mechanical protection against breakage. Once membrane switch ribbon cable 80 has been joined to ribbon connector cable 84, electronic cover 54 is joined to chassis 52 and mechanically fixed into place with screws or other known mechanical means. The fit of LCD 56 with LCD window 96, and electronic cover 54 with chassis 52 is such to minimize any stray light from entering the inside of electronic sensor housing 51. Furthermore, signal sensor housing 70 and reference sensor housing 76 are so designed so as to totally encapsulate signal sensor 68 and reference sensor 74 such that only light passing through signal sensing housing port 88 and reference sensor housing port 92 is allowed to reach signal sensor 66 and reference sensor 72 respectively. Electronic cover 54, chassis 52, battery cover 60, signal sensor housing 70, and reference sensor housing 76 are all made of opaque material (with the exception of LCD window 96). Batteries 64 are then inserted into battery receptacle 98 thus providing electrical connection and power for circuit board 78 and all of its attached components. Battery cover 60 is attached in place by mechanical means and electronic housing 51 is thereby completely assembled.

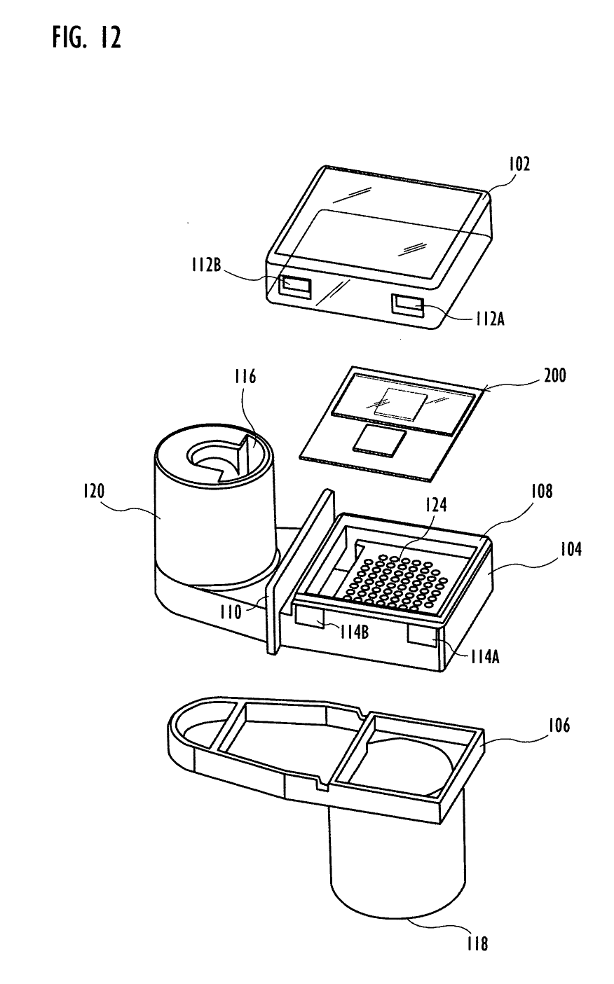

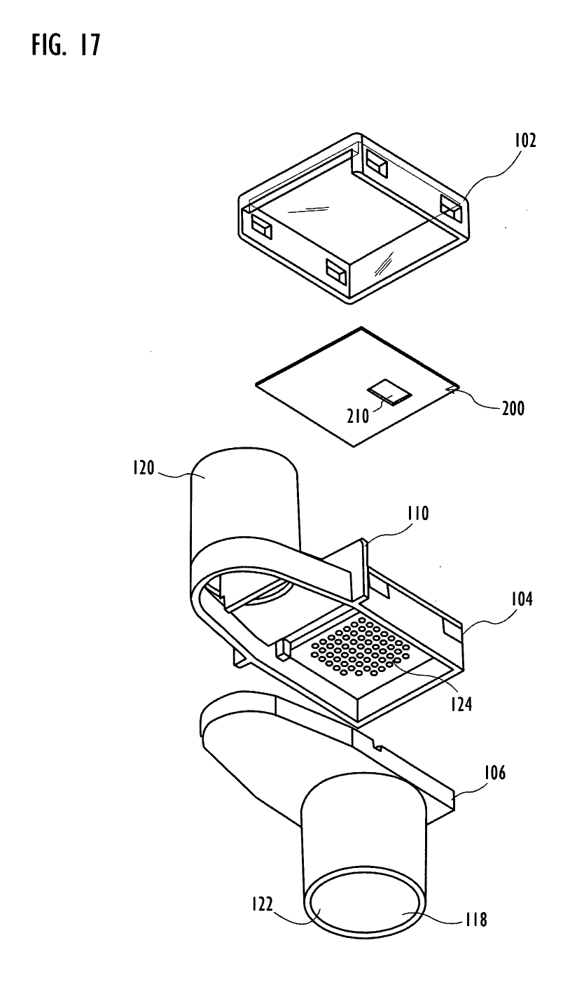

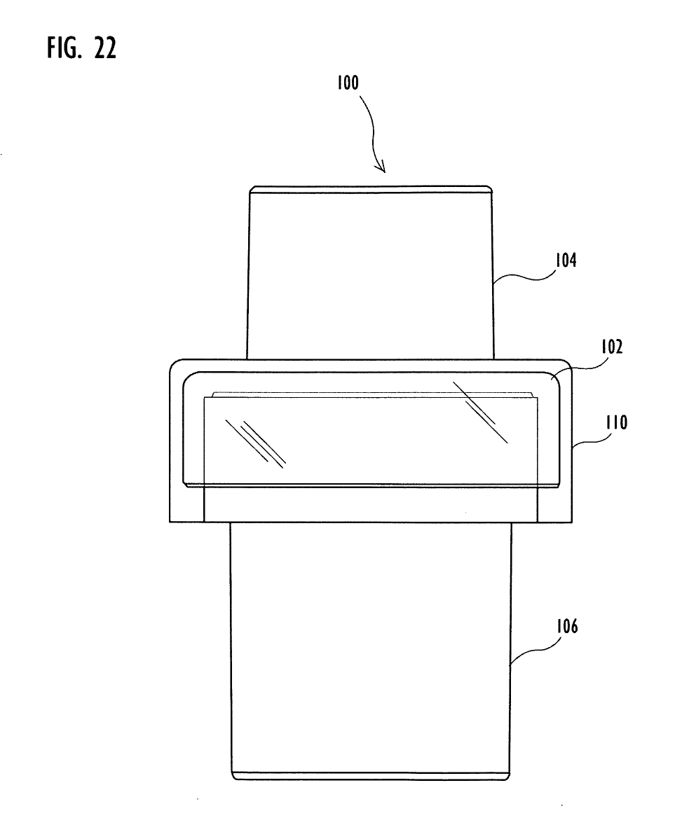

FIG. 12. and FIG. 17. through FIG. 22. show various views of flow housing 100. Flow housing 100 consists of cap 102, indicator assembly 200, flow top 104, and flow base 106. Cap 102 is made of entirely transparent polypropylene. Flow top 104 and flow base 106 are also made of plastic but are entirely opaque.

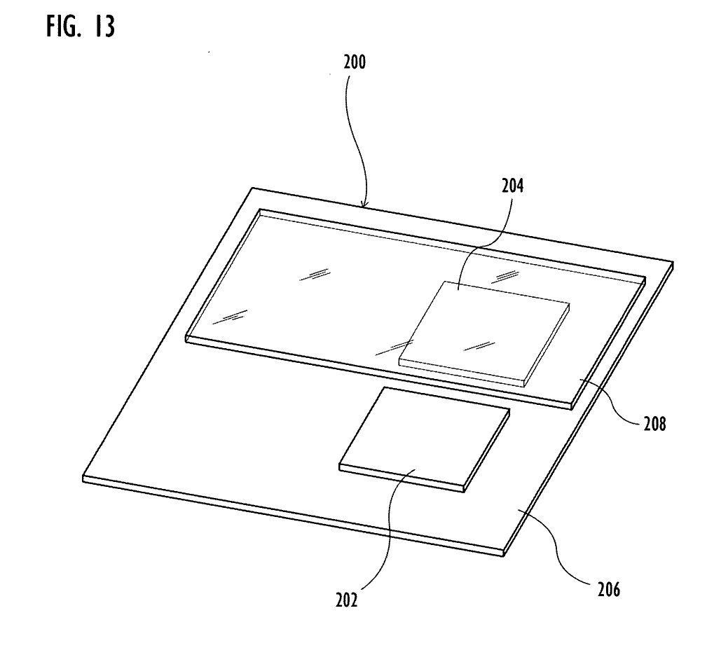

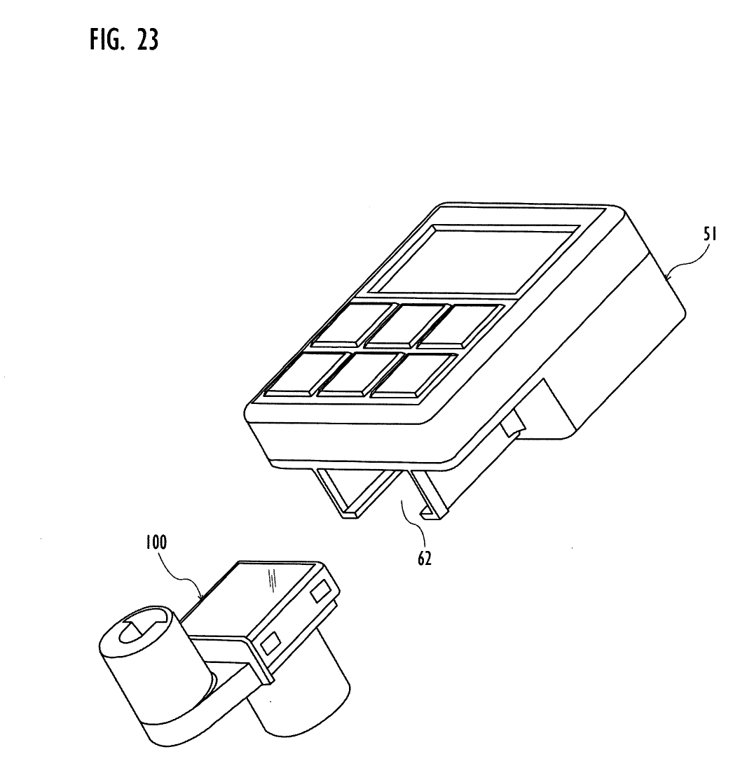

FIG. 13. shows a perspective view of indicator assembly 200. Indicator assembly 200 consists of sensing indicator 202, reference indicator 204, indicator base 206, and reference barrier 208. Sensing indicator 202 and reference indicator 204 are made in identical manner and shape and drawn from the same lot. Sensing indicator 202 and reference indicator 204 were made by the method described in Published U.S. Pat. No. 7,578,971 to Ratner et al using the following components: sodium phenoxide trihydrate (Sigma Aldrich part number 318191), Aliquat 336 (Sigma Aldrich part number 205613), thymol blue (Sigma Aldrich part number 32728), Triton X-15 (Sigma Aldrich part number x15), Supor-200 0.2 um (Pall part number SUP0250034), and methanol (Sigma Aldrich part number 179337). Indicator base 206 is shaped to fit within cap 201 and be held in place on top of and captured between lip 108 of flow top 104 and the inside cavity of cap 201. Indicator base 206 is made of 5 mil laminate sheeting (Quill part number 047-11020q) and is punched with sensing flow conduit 210 such that when sensing indicator 202 is placed over sensing flow conduit 210 gas on opposite side of indicator base 206 from sensing indicator 202 is allowed to be in fluid communication with sensing indicator 202 through sensing flow conduit 210. Reference indicator 204 is positioned symmetrically opposite of sensing indicator 202 on the same side of indicator base 206 that sensing indicator 202 is placed on. Reference barrier 208 is made of 1 mil mylar (McMaster Carr part number 8567k14) and of sufficient size to completely cover reference indicator 204 and be heat welded to indicator base 206 in such a manner that a continuous weld circumscribes reference indicator 204 preventing gas that comes into contact with sensing indicator 202 from coming in contact with reference indicator 204. The final position of sensing indicator 202 and reference indicator 204 is such that when the flow housing assembly 100 is coupled with electronic sensor housing 51 through means of flow housing receptacle 62 (refer to FIG. 23 through 27), that sensing indicator 202 is coincident with signal sensor 68 and the illumination from signal illumination source 66, and that reference indicator 204 is coincident with reference sensor 74 and the illumination from reference illumination source 72.

Referring to FIG. 12. cap 102 is equipped with 4 engagement pockets 112A, 112B, 112C, and 112D that, upon indicator assembly 200 being placed within cap 102, allow cap 102 to be snapped into place onto flow top 104 and held in place by engagement of engagement teeth 114A, 114B, 114C, and 114D with engagement pockets 112.

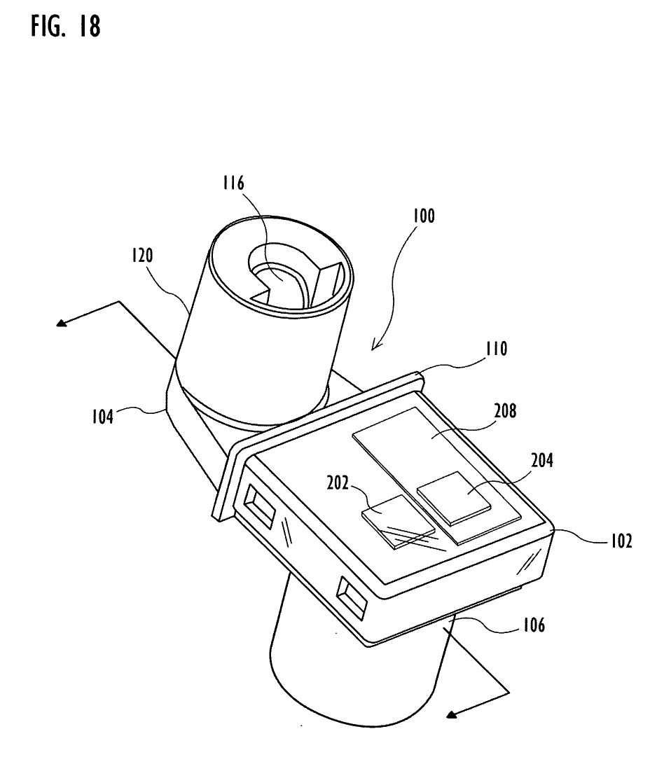

Referring to FIG. 18, Flow top 104 is equipped with light shield 110 such that when flow housing assembly 100 is engaged with electronic sensor housing 51 light shield 110 prevents ambient light from illuminating sensing indicator 202 and reference indicator 204 or interfering with signal sensor 68 and reference sensor 74. Similarly, referring to FIG. 8 electronic sensor housing is equipped with light shroud 63 that functions to hold flow housing assembly 100 in place and also prevent ambient light, through a reflected path, illuminate sensor indicator 202 and reference indicator 204, or from interfering with signal sensor 68 and reference sensor 74.

Referring to FIGS. 8, 24, and 26 electronic sensor housing 51 is equipped with detents 65A and 65B that serves to keep flow housing assembly 100 in correct position when engaged with electronic flow housing 51 by snapping in place about patient port outer cylindrical body 126. The interference between detents 65 and patient port outer cylindrical body 126 is not so large as to prevent a clinician or user from dislodging flow housing assembly 100 when desired.

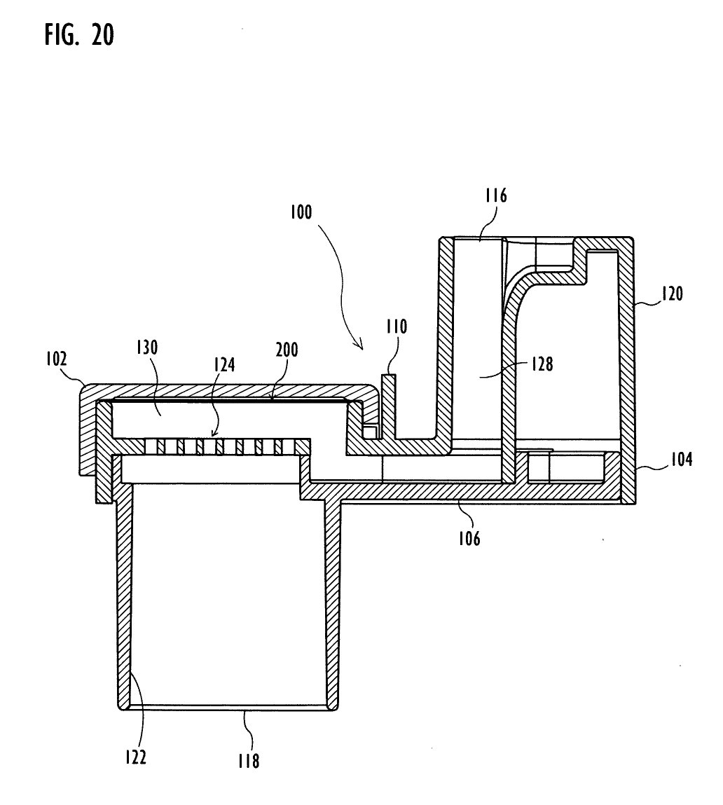

Referring to FIG. 17 through 20 flow base 106 contains patient port 118 and female conical connector 122. Flow top 104 contains distal port 116 and male conical connector 120. Female conical connector 122 serves as a fluid conduit from patient port 116 to flow to the internal geometry of flow housing assembly 100 via flow mesh array 124, and is sized to attach to 15 mm ISO male connectors as are prevalently used with endotracheal tubes and also easily allow for connection of mouthpieces and masks. Flow top 104 includes male conical connector 120 and is sized to fit to 15 mm ISO female connectors, thus the combination of male conical connector 120 and female conical connector 122 easily facilitate placing flow housing assembly 100 between an endotracheal tube or mask and other ventilatory or gas supply devices that are readily available, commonly used, and regularly sized to connect to endotracheal tubes. Thus, as can be seen in FIG. 20, during patient inhalation, ambient or supplied gas is caused to pass through distal port 116, down distal conduit 128, into indicator chamber 130 (where the incoming gas becomes exposed and has contact with sensing indicator 202), through flow mesh array 124, through female conical connector 122 and onto the patient. Similarly, during patient exhalation exhaled gas is caused to pass down female conical connector 122, through flow mesh array 124, into indicator chamber 130 (where the exhaled gas becomes exposed and has contact with sensing indicator 202), along distal conduit 128, and onto distal port 116 where it is in fluid communication with the ambient environment or supplied gas. Upon contact of gas in indicator chamber 130 with sensing indicator 202, the presence of carbon dioxide causes sensing indicator 202 to change color with respect to reference indicator 204, that is illuminated by signal illumination source 66 and reference illumination source 72 respectively, and measured by signal sensor 68 and reference sensor 74 respectively, producing a combined signal which the microprocessor interepets and displays on LCD screen 56.

### Second Example

Another embodiment of the invention is identical to the first example above with the exception that reference illumination source 72, reference sensor 74, reference sensor housing 76, reference illumination source boss carriage 90, reference sensor housing port 92, reference indicator 204, and reference barrier 208 are all removed and replaced with a thermistor, or other temperature sensing device, from which the microprocessor and/or logical circuits can gain information on ambient temperature to make an appropriate correction in displayed CO2 concentration value. The first example has the advantage of more accurate temperature correction and the secondary and minute advantage of controlling for the process chemisty variability of the sensor indicator 202 and reference indicator 204 from lot to lot. The second example has the advantage of being of simpler design and low cost. Although the difference in performance of the two devices has beens shown to not be large, the embodiment of the first example may be preferable for EMTs and are clinicians working in outdoor environments where the temperature is known to fluctuate more, and the embodiment of the second example may be preferable for clinicians working in institutions and hospitals where the ambient conditions are not expected to vary much and cost is larger factor.

### Third Example

Another embodiment of the invention is identical to the second example except that it does not include any temperature compensation at all. Although under controlled ambient conditions found in an institution in most cases, the introduced error may be acceptable.

Nonetheless, the cost of a thermistor is so incidental to the overall cost of the invention it is hard to imagine that the small cost savings would be worth the known variability to temperature that has been shown to exist and the resulting risk to the patient.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A detection sensor assembly comprising;
a. an indicator sensor;
b. a flow housing comprising two fluidic ports;
c. an indicator target comprising at least one indicator moiety;
d. an indicator window;
wherein said indicator target is contained internal to said flow housing and is viewable from a point external to said flow housing by means of said indicator window;
wherein said indicator sensor is affixed external to said flow housing; and
wherein said indicator sensor is responsive to at least one indicator moiety influenced by changing fluidic environments presented to said indicator target.

2. A detection sensor assembly as in claim 1, wherein said indicator sensor further comprises an illumination source.

3. A detection sensor assembly as in claim 1, wherein said fluidic environment is a gaseous environment.

4. A detection sensor assembly as in claim 1, wherein said at least one indicator moiety is a chemistry which induces a colorimetric response.

5. A detection sensor assembly as in claim 1, wherein said indicator sensor is reusable.

6. A detection sensor assembly as in claim 1, wherein said flow housing is disposable.

7. A detection sensor assembly as in claim 1, wherein said indicator sensor responds to changing fluidic environments in real-time.

8. A detection sensor assembly as in claim 1, wherein said indicator sensor is not in equal contact with fluidic environment presented to said indicator target

9. A detection sensor assembly comprising;
a. an indicator sensor with a modular mounting bracket;
b. a flow housing comprising two fluidic ports;
c. an indicator target comprising at least one indicator moiety;
d. an indicator window;
wherein said indicator target is contained internal to said flow housing and is viewable for a point external to said flow housing by means of said indicator window;
wherein said indicator sensor is affixed external to said flow housing by releasable attachment of the modular mounting bracket; and
wherein said indicator sensor is responsive to at least one indicator moiety influenced by changing fluidic environments presented to said indicator target.

10. A detection sensor assembly as in claim 9, wherein said modular mounting bracket allows for universal temporary fitment of said indicator sensor to said flow housing.

11. A detection sensor assembly as in claim 9, wherein said modular mounting bracket allows for specific temporary fitment of said indicator sensor to said flow housing.

12. A detection sensor assembly comprising;
a. an indicator sensor;
b. a flow housing comprising two fluidic ports and a fluidic conduit;
c. a second housing;
d. an indicator target comprising at least one indicator moiety;
e. an indicator window;
f. an illumination source;
g. an illumination window;
wherein said indicator target is contained internal to said flow housing, is in fluidic communication with said fluidic conduit, and is viewable from a point external to said flow housing by means of said indicator window;
wherein indicator target is viewable from a point external to said flow housing by means of said illumination window;
wherein said fluidic ports are in fluid communication with said fluidic conduit;
wherein said second housing may be coupled with and detached from said flow housing;
wherein said indicator sensor is included in said second housing;
wherein said indicator sensor is able to receive radiant energy that has been transmitted through or reflected by said indicator target through said indicator window when said second housing is coupled with said flow housing;
wherein said illumination source is external to said flow housing;
wherein said illumination source directs radiant energy onto said indicator target through said illumination window; and
wherein said indicator sensor is responsive to at least one indicator moiety influenced by changing fluidic environments presented to said indicator target;

13. A detection sensor assembly as in claim 12, wherein said indicator window and illumination window are one and the same.

14. A detection assembly as in claim 12, wherein the illumination source is contained within said second housing.

15. A detection sensor assembly as in claim 12, wherein said indicator sensor further comprises a second indicator target.

16. A detection sensor assembly as in claim 15, wherein said second indicator target is not in fluidic communication with said fluidic conduit.

17. A detection sensor assembly as in claim 16, wherein comparison of said first indicator target with said second indicator target provides temperature correction.

18. A detection sensor assembly as in claim 16, wherein said first and second indicator targets are produced in a same process batch of chemistry, wherein said indicator sensor is able to provide chemistry process variability correction.
